(19) United States
(12) Patent Application Publication
(10) Pub. No.: US 2022/0035825 A1
(43) Pub. Date: Feb. 3, 2022

(54) NAME TYPE IDENTIFICATION

(71) Applicant: VMware, Inc., Palo Alto, CA (US)

(72) Inventors: Prateek JAIN, Cupertino, CA (US); Stephen SCHMIDT, Portola Valley, CA (US); Scott TILNEY, San Jose, CA (US); Pallavi VANAJA, Sunnyvale, CA (US); Gary GROSSI, San Jose, CA (US); Michelle LEE, Berkeley, CA (US)

(73) Assignee: VMware, Inc., Palo Alto, CA (US)

(21) Appl. No.: 17/152,035

(22) Filed: Jan. 19, 2021

Related U.S. Application Data
(60) Provisional application No. 63/059,025, filed on Jul. 30, 2020.

(51) Int. Cl. G06F 16/2457; G06N 7/00

(52) U.S. Cl. CPC G06F 16/24578; G06N 7/005

(57) ABSTRACT

In a computer-implemented method for name type identification, a list of names is received. A probability that each name of the list of names is one of a given name and a surname is determined. Each name of the list of names is determined as one of a given name and a surname based on the probability. Entities of the list of names are determined based on the identifying each name of the list of names as one of a given name and a surname, wherein an entity includes one of a given name, a surname, and a given name/surname combination.

### RELATED APPLICATIONS

This application claims priority to and the benefit of co-pending U.S. Patent Provisional Patent Application 63/059,025, filed on Jul. 30, 2020, entitled “CONVERSATIONAL INTERFACE ENHANCEMENTS,” by Jain et al., having Attorney Docket No. G800.PRO, and assigned to the assignee of the present application, which is incorporated herein by reference in its entirety.

### BACKGROUND

Conversational interfaces, often referred to as virtual assistants, are types of user interfaces for computers that emulate human conversation for translating human speech commands into computer-actionable commands. Examples of virtual assistants include Apple's Siri and Amazon's Alexa. A bot is an example of a software application that can utilize a conversational interface for performing designed operations.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 is a block diagram illustrating an example system for name type identification, in accordance with embodiments.

FIG. 2A is a block diagram illustrating an example name type probability determiner, in accordance with embodiments.

FIG. 2B illustrates an example directory of names, an example frequency distribution table, and an example relative frequency distribution table, according to an embodiment.

FIGS. 2C through 2F are example operations and accompanying pseudocode for an example name type probability determination, in accordance with embodiments.

FIG. 3 is a black diagram illustrating an example name type determiner, in accordance with embodiments.

FIG. 4 is a black diagram illustrating an example entity identifier, in accordance with embodiments.

FIG. 5 is a black diagram illustrating an example system for executing an action on a list of names, in accordance with embodiments.

FIG. 6 is a block diagram illustrating an example computer system upon which embodiments of the present invention can be implemented.

FIG. 7 is a flow diagram illustrating an example method for name type identification, in accordance with embodiments.

FIG. 8 is a flow diagram illustrating an example method for determining a probability that each name of the list of names is one of a given name and a surname, in accordance with embodiments.

FIG. 9 is a flow diagram illustrating an example method for determining whether consecutive names of a list of names are a given name/surname combination, in accordance with embodiments.

FIG. 10 is a flow diagram illustrating an example method for executing an action on a list of names, in accordance with embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### NOTATION AND NOMENCLATURE

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “determining,” “identifying,” “comparing,” “generating,” “executing,” “storing,” or the like, refer to the actions and processes of an electronic computing device or system such as: a host processor, a processor, a memory, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions or code residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, code and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Discussion begins with a description of an example system for name type identification, according to various embodiments. Example operations of a system for name type identification are then described. An example computer system environment, upon which embodiments of the present invention may be implemented, is then described.

Example embodiments described herein provide systems and methods of name type identification. In accordance with the described embodiments, a list of names is received. A probability that each name of the list of names is one of a given name and a surname is determined. Each name of the list of names is determined as one of a given name and a surname based on the probability. Entities of the list of names are determined based on the identifying each name of the list of names as one of a given name and a surname, wherein an entity includes one of a given name, a surname, and a given name/surname combination.

When given a list of identified names (e.g., given names and surnames), it is not always obvious for a computer to tell which is a given name (also referred to herein as a “first name”), which is a surname (also referred to herein as a “last name”), and which given name and surname, if any, belong together. This is particularly useful in natural language interface applications where names are extracted as entities but not distinguished by type of name.

Given a list of names (in this case names are strings that have been identified by as name entities as part of a natural language query), the described system will determine which are given names, which are surnames, and which given name and surname pairs are part of the same full name, to identify the entities of the list of names. It should be appreciated that for purposes of the present application, a given name does not include a middle name, where a middle name is a name between a given name and a surname. However, it should be further appreciated that principles of the present application can be applied to a middle name as well, for purposes of middle name and first name/middle name/surname combinations.

The described embodiments provide a probabilistic of name type (given name or surname and grouping of adjacent first names and surnames) based on a probability that a name is a given name or a surname. In some embodiments, the probability is based on an ingested directory of names identifying name types (e.g., given name and surname or first name and last name) for the names.

In one embodiment, a frequency of a name appearing as a given name and a frequency of a name appearing as a surname is determined and stored as a frequency distribution table. A relative frequency distribution table is then generated (e.g., during runtime) for the names being analyzed.

Embodiments described herein provide for selection and execution of an action with multiple contact entities. When completing a task with a natural language interface application, it is useful to be able to specific multiple entities recognized as contacts and execute and action using that list. Conventional systems have difficulty performing operations on a list of multiple entities as they typically have difficulty grouping the names of the list. Existing natural language interface applications will extract entities but only allow an action to be executed with a single entity even if a user attempts to specify multiple separate entities.

The described system extracts multiple entities from a natural language query (e.g., using the name type identification described above) and allows that list to be used to execute a given action. In one embodiment, once the names are extracted, the system can apply the action to each entity, thereby automatically converting the action on multiple contact entities into a series of individual actions.

### Example System for Name Type Identification

Example embodiments described herein provide systems and methods for name type identification, where a name type includes a given name (e.g., a first name) and a surname (e.g., a last name). In accordance with some embodiments, a list of names is received. A probability that each name of the list of names is one of a given name and a surname is determined. Each name of the list of names is determined as one of a given name and a surname based on the probability. Entities of the list of names are determined based on the identifying each name of the list of names as one of a given name and a surname, wherein an entity includes one of a given name, a surname, and a given name/surname combination.

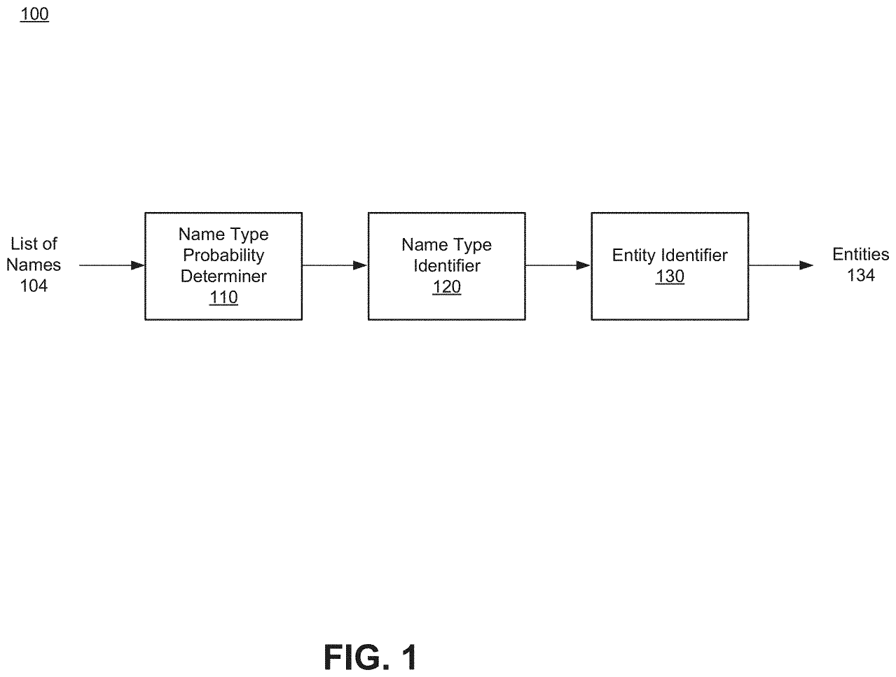

FIG. 1 is a block diagram illustrating an example system 100 for name type identification, in accordance with embodiments. In accordance with various embodiments, system 100 includes name type probability determiner 110, name type identifier 120, and entity identifier 130. It should be appreciated that name type probability determiner 110, name type identifier 120, and entity identifier 130 can be under the control of a single component of an enterprise computing environment (e.g., a virtualization infrastructure or computer system 600) or can be distributed over multiple components (e.g., a virtualization infrastructure or a cloud-based infrastructure).

A list of names 104 is received at name type probability determiner 110 of system 100. The list of names 104 includes given names (e.g., first names) and surnames (e.g., last names) which may or may not be paired together as a given name/surname combination. System 100 is operable to determine whether names of the list of names 104 are given names or surnames, and which (if any) given names and surnames are part of a given name/surname combination. In some embodiments, the list of names 104 is received from a natural language or conversational interface application that converts spoken words into computer-understandable information and/or commands. For example, list of names 104 includes character strings that are identified as name entities as part of a natural language query.

When receiving a list of names at a natural language interface, conventional natural language interfaces are unable to identify which names are given names and which names are surnames, and which of the names are paired together as a single entity as a given name/surname combination. For example, the list of names 104 may include: John, Mary Jones, Joe Smith, Peter James, and Susan. In such an example, John, Mary, Joe, Peter, and Susan are given names, Jones, Smith, and James are surnames, and Mary Jones, Joe Smith, and Peter James are given name/surname combination. System 100 is operable to receive the list of names 104 and identify the separate entities of the list of names 104.

Name type probability determiner 110 is configured to determine a probability that each name of the list of names 104 is one of a given name and a surname. In one embodiment, the probability that each name of the list of names 104 is one of a given name and a surname is determined includes comparing each name of the list of names 104 to a relative frequency distribution table of names of a directory. A relative frequency distribution table of names of the directory includes a relative frequency that each name of the directory is a given name and a relative frequency that each name of the directory is a surname.

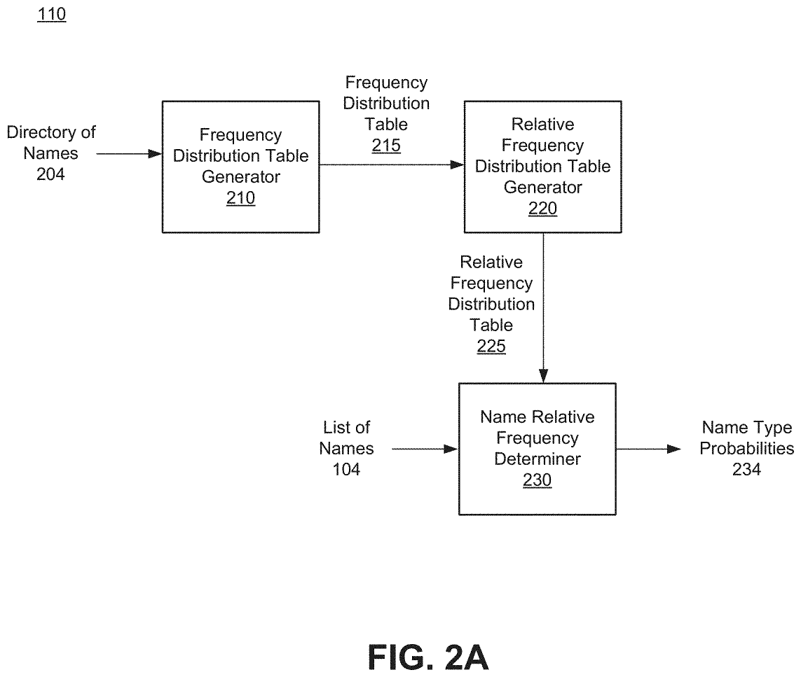

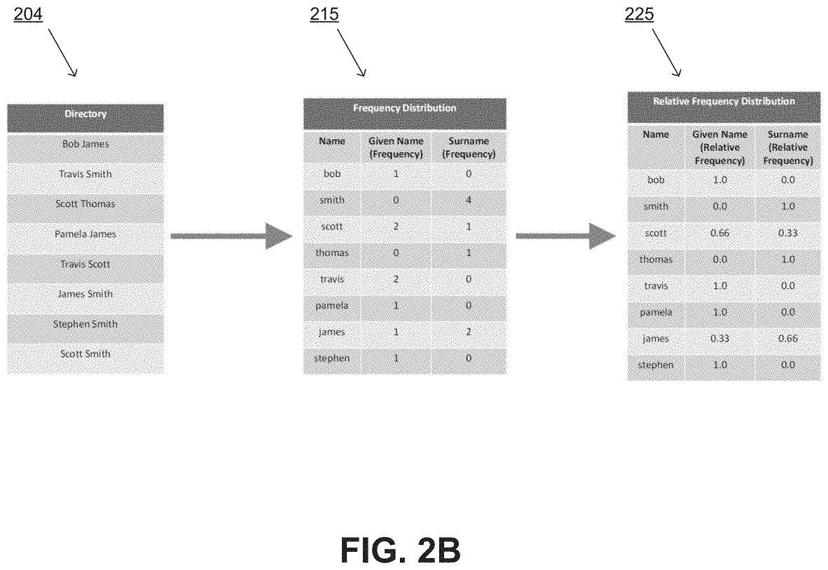

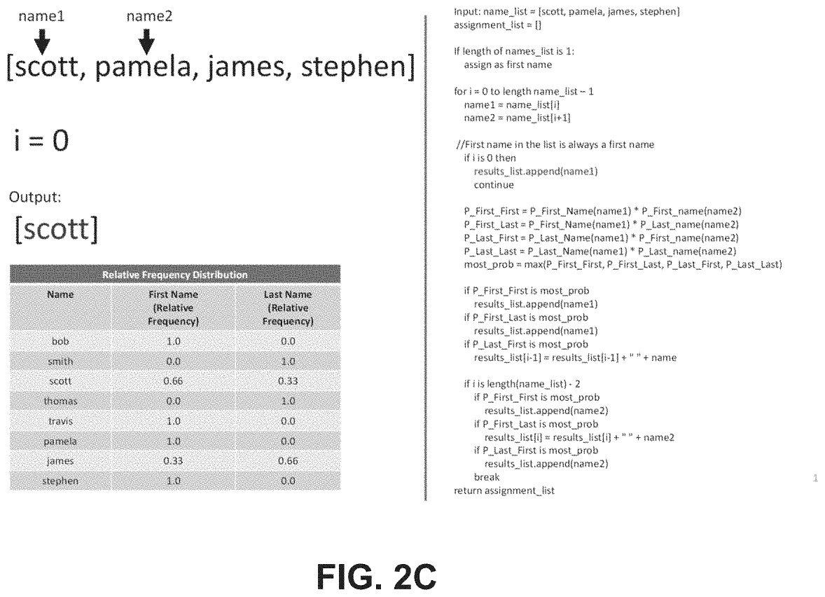

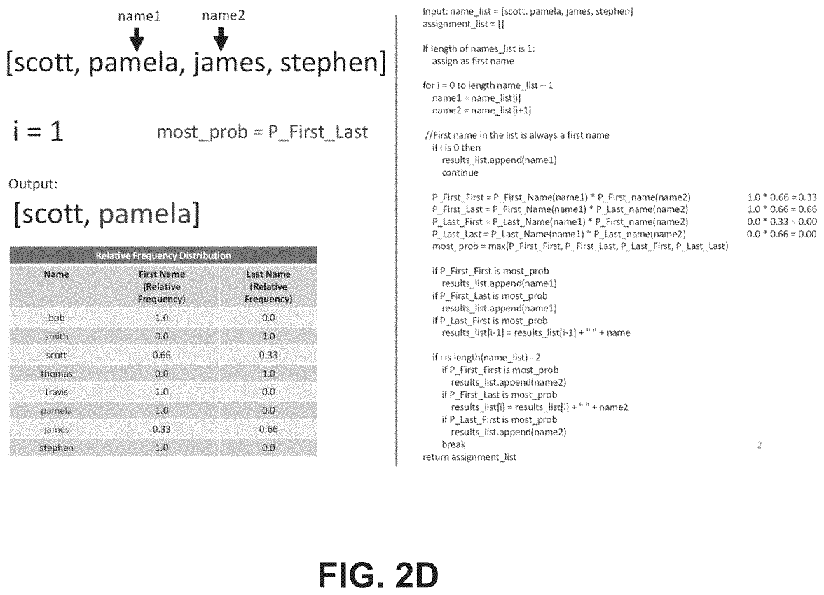

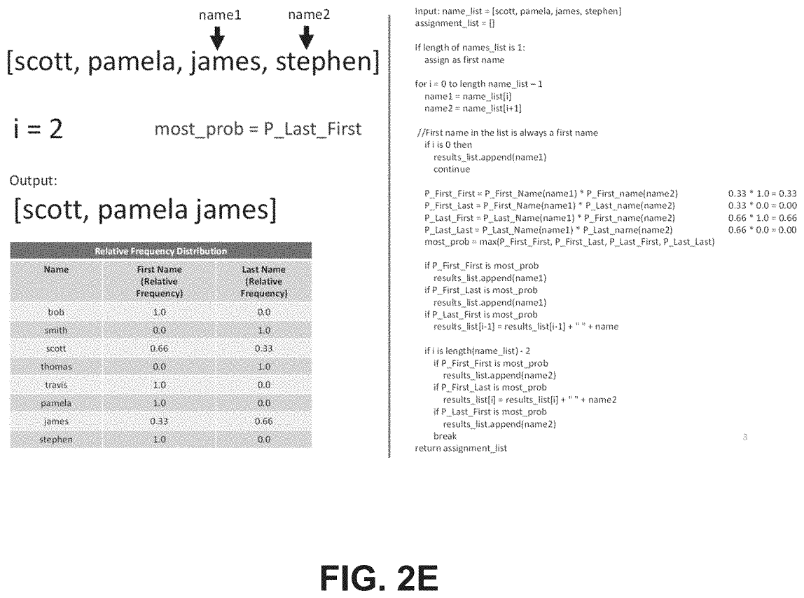

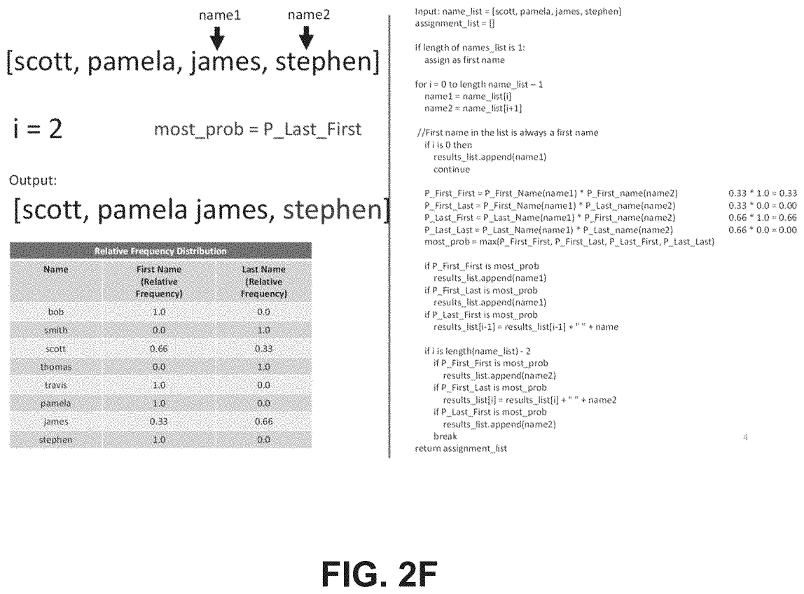

FIG. 2A is a block diagram illustrating an example name type probability determiner 110, in accordance with embodiments. Name type probability determiner 110 is configured to determine a probability that each name of the list of names is one of a given name and a surname by comparing list of names 104 to relative frequency distribution table 225.

A directory of names 204 is received at a frequency distribution table generator 210. In one embodiment, the directory is an enterprise directory. In another embodiment, the directory is a personal contact list. It should be appreciated that directory of names 204 can be any directory of names without limitation, of which an enterprise directory and a personal contact list are examples.

FIG. 2B illustrates an example directory of names 204, where the first name listed of a pair of names is a given name and the second name listed is a surname. Frequency distribution table generator 210 generates a frequency distribution table 215 based on the directory of names 204. Frequency distribution table 215 indicates the frequency (e.g., the number of times) each name of the directory of names 204 appears as a given name and the frequency each name of the directory of names 204 appears as a surname. FIG. 2B illustrates an example frequency distribution table 215 based on the example directory of names 204. For instance, the name “bob” appears in directory of names 204 as a given name one time and does not appear as a surname, and the name “scott” appears in directory of names 204 as a given name two times and appears in directory of names 204 as a surname one time.

Frequency distribution table 215 is received at relative frequency distribution table generator 220, where relative frequency distribution table generator 220 is configured to generate a relative frequency distribution table 225 based on the frequency distribution table 215. Relative frequency distribution table 225 indicates the relative frequency (e.g., percent) each name of the directory of names 204 appears as a given name and the relative frequency each name of the directory of names 204 appears as a surname. FIG. 2B illustrates an example relative frequency distribution table 225 based on the example frequency distribution table 215. For instance, the name “bob” has a relative frequency of 1.0 as a given name and 0.0 as a surname, indicating that “bob” is only used as a given name in directory of names 204, and the name “scott” has a relative frequency of 0.66 as a given name and 0.33 as a surname, indicating that “scott” is used as both a given name and a surname in directory of names 204.

Name relative frequency determiner 230 receives relative frequency distribution table 225 and list of names 104 for generating name type probabilities 234. Name relative frequency determiner 230 compares each name of the list of names 104 to relative frequency distribution table 225 to generate a probability that each name is a given name or a surname. In some embodiments, name relative frequency determiner 230 identifies the first name of list of names 104 as a given name. In some embodiments, name relative frequency determiner 230 operates on pairs of consecutive names of list of names 104 by multiplying the relative frequencies for each name.

For example, with reference to FIGS. 2C through 2F, consider where the list of names 104 includes “scott, pamela, james, stephen”. FIGS. 2C through 2F are example operations and accompanying pseudocode for an example name type probability determination, in accordance with embodiments. With reference to FIG. 2C, the first two names operated on by name relative frequency determiner 230 are “scott” and “pamela”. As “scott” is the first name of the list of names 104, it is identified as a given name.

As illustrated in FIG. 2D, name relative frequency determiner 230 then operates on “pamela” and “james”. The given name frequency and surname relative frequency for each of “pamela” and “james” are multiplied, such that: the given name relative frequency for “pamela” and “james” are multiplied (e.g., 1.0*0.33=0.33); the given name relative frequency for “pamela” and the surname relative frequency for “james” are multiplied (e.g., 1.0*0.66=0.66); the surname relative frequency for “pamela” and the given name relative frequency for “james” are multiplied (e.g., 0.0*0.33=0.0); and the surname relative frequency for “pamela” and “james” are multiplied (e.g., 0.0*0.66=0.0). The resulting determination is that there is a 0.66 probability that “pamela” is a given name, and is output as a given name.

As illustrated in FIGS. 2E and 2F, name relative frequency determiner 230 then operates on “james” and “stephen”, which determines there is a 0.66 probability that “james” is a surname and that “stephen” is a given name. The resulting determinations are that there is a 0.66 probability that “james” is a surname, and is output as a surname, as illustrated in FIG. 2E, and that there is a 0.66 probability that “stephen” is a given name, and is output as a given name, as illustrated in FIG. 2F.

With reference to FIG. 1, name type identifier 120 is configured to determine whether each name of the list of names 104 is a given name or a surname based on the probability received from name type probability determiner 110.

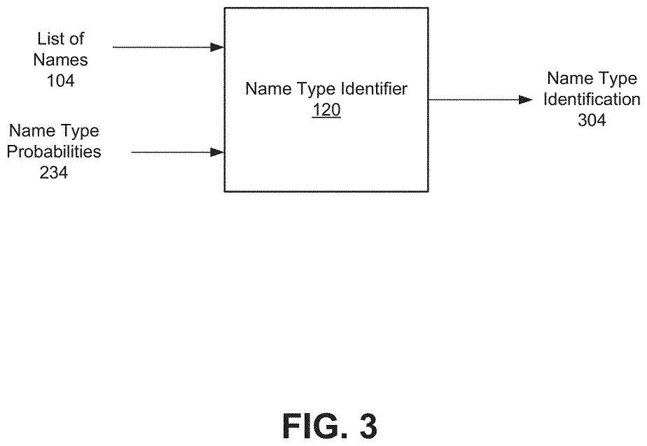

FIG. 3 is a block diagram illustrating an example name type identifier 120, in accordance with embodiments. Name type identifier 120 is configured to determine whether each name of the list of names 104 is a given name or a surname based on name type probabilities 234 received from name type probability determiner 110. Using name type probabilities 234, name type identifier 120 outputs name type identification 304 which indicates whether a name of list of names 104 is a given name or a surname.

With reference to FIG. 1, entity identifier 130 is configured to identify entities of list of names 104 based on the name type identification received from name type identifier 130.

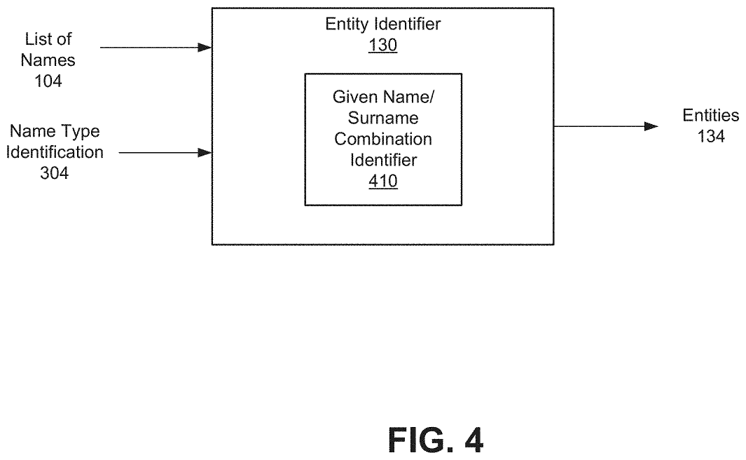

FIG. 4 is a block diagram illustrating an example entity identifier 130, in accordance with embodiments. Entity identifier 130 is configured to determine entities of the list of names 104 based on name type identification 304, where an entity includes one of a given name, a surname, and a given name/surname combination. Entity identifier 130 identifies entities 134 by comparing the list of names 104 to name type identification 304.

Given name/surname combination identifier 410 is configured to identify given name/surname combinations of the list of names 104. In one embodiment, given name/surname combinations of the list of names 104 are identified according to the identifying each name as one of a given name and surname. Responsive to identifying consecutive names of the list of names 104 as a given name followed by a surname, given name/surname combination identifier 410 identifies the consecutive names as a given name/surname combination.

FIG. 1 is configured to output entities 134 based on the input list of names 104, where entities 134 are distinct names belonging to the same person. The described system extracts multiple entities from a natural language query (e.g., using the name type identification described above) and allows that list to be used to execute a given action. In one embodiment, once the names are extracted, the system can apply the action to each entity, thereby automatically converting the action on multiple contact entities into a series of individual actions.

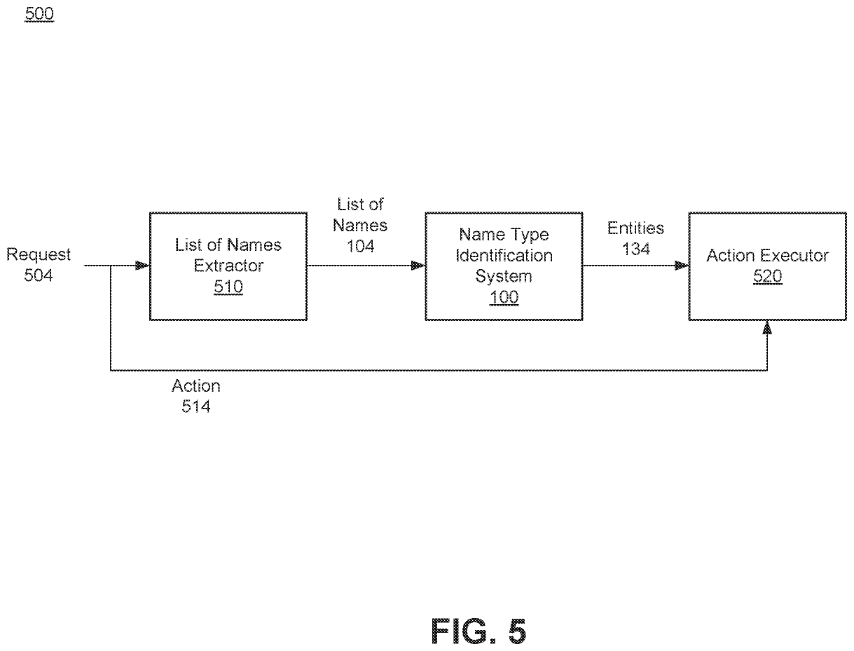

Embodiments described herein provide for selection and execution of an action with multiple contact entities. FIG. 5 is a black diagram illustrating an example system 500 for executing an action on a list of names, in accordance with embodiments. A request 504 to execute an action 514 is received at system 500. In one embodiment, list of names extractor 510 receives request 504 and extracts list of names 104 from request 504. List of names 104 is received at name type identification system 100 (as described above in accordance with FIGS. 1 through 4) which generates entities 134.

Action executor 520 receives entities 134 and action 514, and is operable to execute action 514 on entities 134. It should be appreciated that action 514 can include, without limitation: sending an email, sending an appointment invitation, sending a reminder, sending a text message, or any other type of action to be taken on multiple contact entities.

System 500 extracts multiple entities from a natural language query (e.g., using the name type identification of FIGS. 1 through 4) and allows that entity list to be used to execute a given action. In one embodiment, once the names are extracted, system 500 can apply the action to each entity, thereby automatically converting the action 514 on multiple contact entities 134 into a series of individual actions.

The described embodiments allow for entity identification based on a list of names received at a conversational interface. Embodiments also allow for execution of actions with multiple entities responsive to receiving a request for execution of an action on a list of names. Accordingly, the described embodiments improve performance of conversational interfaces. Moreover, embodiments of the present invention amount to significantly more than merely using a computer to perform the name type identification. Instead, embodiments of the present invention specifically recite a novel process, rooted in computer technology, for name type identification to identify entities, and to perform execution of actions on the entities, to overcome a problem specifically arising in the realm of conversational interfaces.

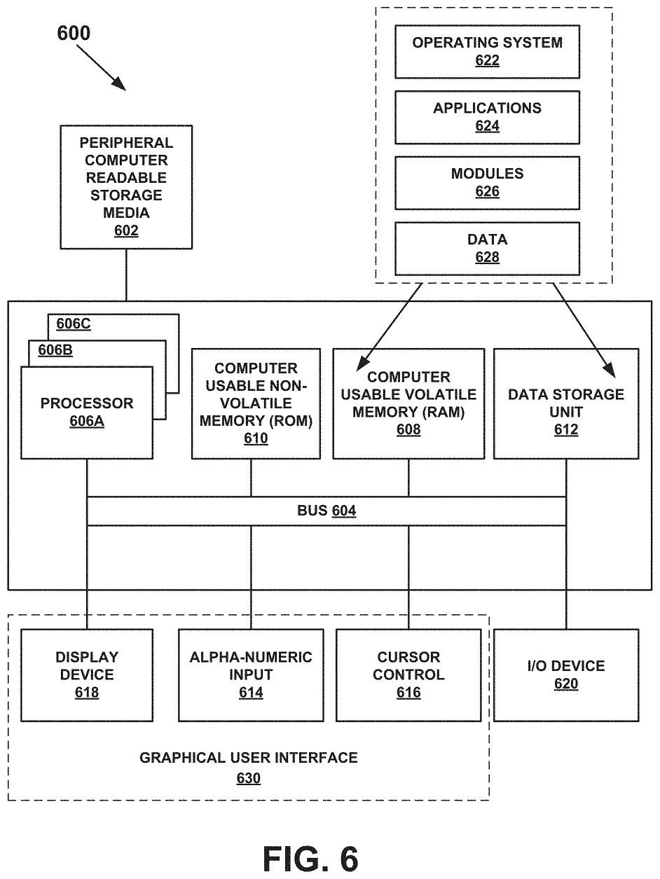

FIG. 6 is a block diagram of an example computer system 600 upon which embodiments of the present invention can be implemented. FIG. 6 illustrates one example of a type of computer system 600 (e.g., a computer system) that can be used in accordance with or to implement various embodiments which are discussed herein.

It is appreciated that computer system 600 of FIG. 6 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 600 of FIG. 6 is well adapted to having peripheral tangible computer-readable storage media 602 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 600 of FIG. 6 includes an address/data bus 604 for communicating information, and a processor 606A coupled with bus 604 for processing information and instructions. As depicted in FIG. 6, computer system 600 is also well suited to a multi-processor environment in which a plurality of processors 606A, 606B, and 606C are present. Conversely, computer system 600 is also well suited to having a single processor such as, for example, processor 606A. Processors 606A, 606B, and 606C may be any of various types of microprocessors. Computer system 600 also includes data storage features such as a computer usable volatile memory 608, e.g., random access memory (RAM), coupled with bus 604 for storing information and instructions for processors 606A, 606B, and 606C. Computer system 600 also includes computer usable non-volatile memory 610, e.g., read only memory (ROM), coupled with bus 604 for storing static information and instructions for processors 606A, 606B, and 606C. Also present in computer system 600 is a data storage unit 612 (e.g., a magnetic or optical disc and disc drive) coupled with bus 604 for storing information and instructions. Computer system 600 also includes an alphanumeric input device 614 including alphanumeric and function keys coupled with bus 604 for communicating information and command selections to processor 606A or processors 606A, 606B, and 606C. Computer system 600 also includes a cursor control device 616 coupled with bus 604 for communicating user input information and command selections to processor 606A or processors 606A, 606B, and 606C. In one embodiment, computer system 600 also includes a display device 618 coupled with bus 604 for displaying information.

Referring still to FIG. 6, display device 618 of FIG. 6 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, touch screen, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. Computer system 600 is also well suited to having a cursor directed by other means such as, for example, voice commands. In various embodiments, alphanumeric input device 614, cursor control device 616, and display device 618, or any combination thereof (e.g., user interface selection devices), may collectively operate to provide a graphical user interface (GUI) 630 under the direction of a processor (e.g., processor 606A or processors 606A, 606B, and 606C). GUI 630 allows user to interact with computer system 600 through graphical representations presented on display device 618 by interacting with alphanumeric input device 614 and/or cursor control device 616.

Computer system 600 also includes an I/O device 620 for coupling computer system 600 with external entities. For example, in one embodiment, I/O device 620 is a modem for enabling wired or wireless communications between computer system 600 and an external network such as, but not limited to, the Internet. In one embodiment, I/O device 620 includes a transmitter. Computer system 600 may communicate with a network by transmitting data via I/O device 620. In accordance with various embodiments, I/O device 620 includes a microphone for receiving human voice or speech input (e.g., for use in a conversational or natural language interface).

Referring still to FIG. 6, various other components are depicted for computer system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer-readable storage media.

### Example Methods of Operation

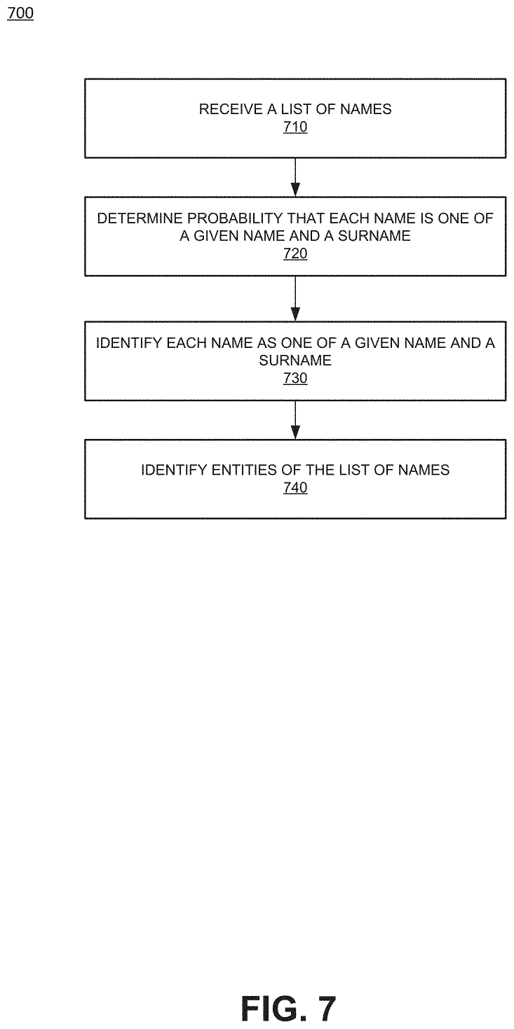

The following discussion sets forth in detail the operation of some example methods of operation of embodiments. With reference to FIGS. 7 through 10, flow diagrams 700, 800, 900, and 1000 illustrate example procedures used by various embodiments. The flow diagrams include some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 600). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in the flow diagrams may be performed in an order different than presented and/or not all of the procedures described in the flow diagrams may be performed. It is further appreciated that procedures described in the flow diagrams may be implemented in hardware, or a combination of hardware with firmware and/or software provided by computer system 600.

FIG. 7 is a flow diagram 700 illustrating an example method for name type identification, in accordance with embodiments. At procedure 710 of flow diagram 700, a list of names is received. At procedure 720, a probability that each name of the list of names is one of a given name and a surname is determined.

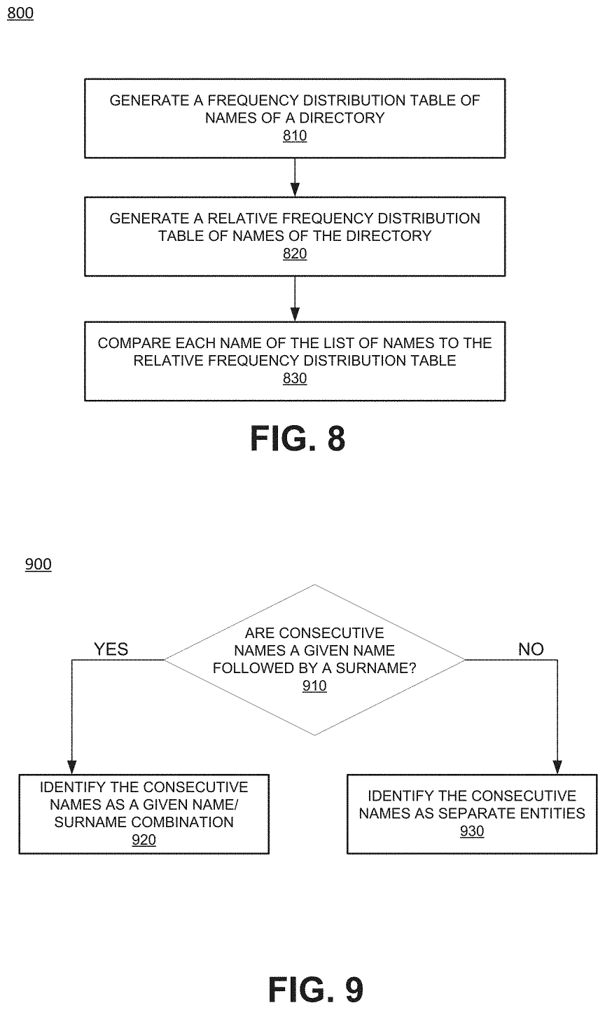

In one embodiment, procedure 720 is performed according to flow diagram 800 of FIG. 8. FIG. 8 is a flow diagram 800 illustrating an example method for determining a probability that each name of the list of names is one of a given name and a surname, in accordance with embodiments. At procedure 810 of flow diagram 800, a frequency distribution table of names of the directory is generated, where the frequency distribution table of names of the directory includes a frequency that each name of the directory is a given name and a frequency that each name of the directory is a surname. In one embodiment, the directory is an enterprise directory. In another embodiment, the directory is a personal contact list.

At procedure 820, a relative frequency distribution table of names of the directory is generated based on the frequency distribution table of names of the directory, where the relative frequency distribution table of names of the directory includes a relative frequency that each name of the directory is a given name and a relative frequency that each name of the directory is a surname.

In one embodiment, as shown at procedure 830, determining the probability that each name of the list of names is one of a given name and a surname includes comparing each name of the list of names to a relative frequency distribution table of names of a directory.

With reference to FIG. 7, at procedure 730, each name of the list of names is determined as one of a given name and a surname based on the probability. In one embodiment, procedure 730 is performed according to flow diagram 900 of FIG. 9.

FIG. 9 is a flow diagram 900 illustrating an example method for determining whether consecutive names of a list of names are a given name/surname combination, in accordance with embodiments. At procedure 910 of flow diagram 900, it is determined whether consecutive names are a given name followed by a surname. Provided that the consecutive names are a given name followed by a surname, as shown at procedure 920, the consecutive names are identified as given name/surname combination, where the consecutive names are a given name followed by a surname is a single entity. Provided that the consecutive names are not a given name followed by a surname, as shown at procedure 930, the consecutive names are identified as separate entities (e.g., two given names)

With reference to FIG. 7, at procedure 740, entities of the list of names are determined based on the identifying each name of the list of names as one of a given name and a surname, wherein an entity includes one of a given name, a surname, and a given name/surname combination.

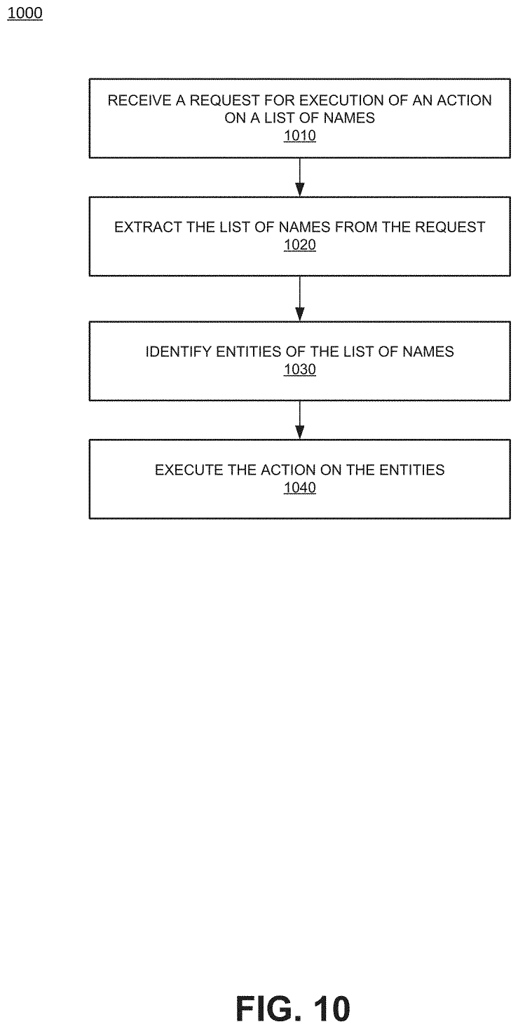

FIG. 10 is a flow diagram 1000 illustrating an example method for executing an action on a list of names, in accordance with embodiments. At procedure 1010 of flow diagram 1000, a request for execution of an action on the list of names is received. In one embodiment, the request is received at a conversational interface. In one embodiment, the list of names is received in the request for execution of an action. In one embodiment, as shown at procedure 1020, the list of names is extracted from the request.

At procedure 1030, entities of the list of names are identified. In various embodiments, procedure 1030 is performed according to flow diagram 700 of FIG. 7. At procedure 1040, the action is executed on the entities of the list of names based on the identifying the entities of the list of names.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A computer-implemented method for name type identification, the method comprising:
receiving a list of names;
determining a probability that each name of the list of names is one of a given name and a surname;
identifying each name of the list of names as one of a given name and a surname based on the probability; and
identifying entities of the list of names based on the identifying each name of the list of names as one of a given name and a surname, wherein an entity comprises one of a given name, a surname, and a given name/surname combination.

2. The method of claim 1, wherein the determining the probability that each name of the list of names is one of a given name and a surname comprises:
comparing each name of the list of names to a relative frequency distribution table of names of a directory, wherein the relative frequency distribution table of names of the directory comprises a relative frequency that each name of the directory is a given name and a relative frequency that each name of the directory is a surname.

3. The method of claim 2, further comprising:
generating a frequency distribution table of names of the directory, wherein the frequency distribution table of names of the directory comprises a frequency that each name of the directory is a given name and a frequency that each name of the directory is a surname.

4. The method of claim 3, further comprising:
generating the relative frequency distribution table of names of the directory based on the frequency distribution table of names of the directory.

5. The method of claim 2, wherein the directory is an enterprise directory.

6. The method of claim 2, wherein the directory is a personal contact list.

7. The method of claim 1, further comprising:
identifying given name/surname combinations of the list of names according to the identifying each name as one of a given name and surname.

8. The method of claim 7, wherein the identifying the given name/surname combinations of the list of names according to the identifying each name as one of a given name and surname comprises:
responsive to identifying consecutive names of the list of names as a given name followed by a surname, identifying the consecutive names as a given name/surname combination.

9. The method of claim 7, further comprising:
receiving a request for execution of an action on the list of names; and
executing the action on the entities of the list of names based on the identifying the entities of the list of names.

10. The method of claim 9, further comprising:
extracting the list of names from the request.

11. The method of claim 9, wherein the request is received at a conversational interface.

12. A non-transitory computer readable storage medium having computer readable program code stored thereon for causing a computer system to perform a method for name type identification, the method comprising:
receiving a list of names;
determining a probability that each name of the list of names is one of a given name and a surname;
identifying each name of the list of names as one of a given name and a surname based on the probability;
identifying given name/surname combinations of the list of names according to the identifying each name as one of a given name and surname; and
identifying entities of the list of names based on the identifying each name of the list of names as one of a given name and a surname and the identifying the given name/surname combinations of the list of names, wherein an entity comprises one of a given name, a surname, and a given name/surname combination.

13. The non-transitory computer readable storage medium of claim 12, wherein the determining the probability that each name of the list of names is one of a given name and a surname comprises:
comparing each name of the list of names to a relative frequency distribution table of names of a directory, wherein the relative frequency distribution table of names of the directory comprises a relative frequency that each name of the directory is a given name and a relative frequency that each name of the directory is a surname.

14. The non-transitory computer readable storage medium of claim 13, the method further comprising:
generating a frequency distribution table of names of the directory, wherein the frequency distribution table of names of the directory comprises a frequency that each name of the directory is a given name and a frequency that each name of the directory is a surname.

15. The non-transitory computer readable storage medium of claim 14, the method further comprising:
generating the relative frequency distribution table of names of the directory based on the frequency distribution table of names of the directory.

16. The non-transitory computer readable storage medium of claim 12, wherein the identifying the given name/surname combinations of the list of names according to the identifying each name as one of a given name and surname comprises:
responsive to identifying consecutive names of the list of names as a given name followed by a surname, identifying the consecutive names as a given name/surname combination.

17. The non-transitory computer readable storage medium of claim 12, the method further comprising:
receiving a request for execution of an action on the list of names; and
executing the action on the entities of the list of names based on the identifying the entities of the list of names.

18. The non-transitory computer readable storage medium of claim 17, the method further comprising:
extracting the list of names from the request.

19. A computer system comprising:
a data storage unit; and
a processor coupled with the data storage unit, the processor configured to:
receive a list of names;
determine a probability that each name of the list of names is one of a given name and a surname;
identify each name of the list of names as one of a given name and a surname based on the probability;
identify given name/surname combinations of the list of names according to identified given names and surnames; and
identify entities of the list of names based on identified given names, surnames, and given name/surname combinations, wherein an entity comprises one of a given name, a surname, and a given name/surname combination.

20. The computer system of claim 19, wherein the processor is further configured to:
receive a request for execution of an action on the list of names;
extract the list of names from the request; and
execute the action on the entities of the list of names based on identified entities of the list of names.
